(19) United States
(12) Patent Application Publication
(10) Pub. No.: US 2010/0266901 A1
(43) Pub. Date: Oct. 21, 2010

(54) Lithium Oxygen Battery Having Enhanced Anode Environment

(75) Inventor: Lonnie G. Johnson, Atlanta, GA (US)

Correspondence Address: Excellatron-JRD: Legal Department, 263 Decatur Street, Atlanta, GA, 30312, US

(73) Assignee: EXCELLATRON SOLID STATE, LLC, Atlanta, GA (US)

(21) Appl. No.: 12/759,681

(22) Filed: Apr. 13, 2010

Related U.S. Application Data
(60) Provisional application No. 61/212,568, filed on Apr. 13, 2009.

(51) Int. Cl. H01M 4/58

(52) U.S. Cl. 429/231.8; 429/231.95

(57) ABSTRACT

An anode environment mitigates undesired effects of oxygen upon the anode of a lithium-oxygen electrochemical cell. As a means of mitigating oxygen effect, a lithium anode and an air cathode are separated from one another by a lithium-ion-conductive electrolyte separator including material having low oxygen permeability that reduces the amount of oxygen that contacts the anode. As another means of mitigating oxygen effect, a cell comprises lithium-affinity anode material capable of receiving and retaining lithium in a state that is not significantly adversely affected by the presence of oxygen during cell charging and recharging and an air cathode separated by a lithium-ion-conductive electrolyte separator. Lithium-affinity material is capable of drawing lithium thereinto during charging of the cell and retaining the lithium substantially until discharge of the cell. A cell having a lithium-affinity anode may also have a lithium-ion-conductive electrolyte separator including material having low oxygen permeability.

### RELATED APPLICATIONS

This application claims priority from U.S. Provisional Patent Application No. 61/212,568 filed Apr. 13, 2009.

### TECHNICAL FIELD

This invention relates to batteries. More particularly, the invention relates to rechargeable lithium-oxygen battery cells, also known as lithium-air battery cells, having features for enhancing effectiveness of anode reaction therein.

### BACKGROUND OF THE INVENTION

A battery cell, which is often referred to somewhat informally in an abbreviated form as a “battery,” is an electrochemical apparatus typically formed of at least one electrolyte (also referred to as an “electrolytic conductor”) disposed between a pair of spaced apart electrodes. The terms “battery” and “cell” are typically used interchangeably. Batteries have existed for many years. A battery is a particularly useful article that provides stored electrical energy that can be used to energize a multitude of devices, particularly portable devices that require an electrical power source. The need for high-performance and reliable energy sources in modern society is well documented. Lithium batteries (that is, batteries that utilize lithium in some form as anode material) represent a very attractive solution to these energy needs due to their superior energy density and high performance.

Rechargeable (or secondary) lithium-oxygen batteries (also referred to as lithium-air batteries) using pure lithium metal as anodes have been suggested as a power supply. The terms “lithium-air battery” and “lithium-oxygen battery” are typically used interchangeably. A lithium-air (-oxygen) battery employs a cathode the provides a cathode substrate (usually including a catalyst) from which oxygen in either a pure form or oxygen as a constituent of ambient air may be used as a cathode reactant for a battery cell. In addition to the interchangeable terms lithium-air and lithium-oxygen, these batteries are also denoted in abbreviated form by the convention Li/O₂.

Operation of Li/O₂ cells depends on the diffusion of oxygen into the air cathode. As such, high oxygen permeability of the electrolyte is desired for the cell to operate under high rate of discharge conditions. On the other hand, preventing access of oxygen to the anode of such cells can be important for reliable operation. During recharge, lithium ions are conducted across the electrolyte separator with lithium being plated at the metal anode. The recharge process can be complicated due to the formation of low-density lithium dendrites and lithium powder as opposed to a dense lithium metal film. Dendrites are thin protuberances that can grow upon and outwardly of a surface of the anode during recharging of the cell. Lithium dendrites can penetrate the separator and extend to the cathode resulting in internal short circuits within the cell. What is known as mossy lithium can be formed during recharge. In the presence of oxygen, mossy lithium can be oxidized into mossy lithium oxide. A thick layer of lithium oxide on the anode is a problem because it can increase the impedance of the cell and thereby lower cell performance.

A high rate of charge/discharge capacity fade has been a long-standing problem for rechargeable lithium-air batteries and has represented a significant barrier to their commercialization. The formation of mossy lithium powder and dendrites at the anode-electrolyte interface during cell recharge are significant contributors to capacity fade and cell failure problems.

As a solution to some of the problems described above, lithium-oxygen batteries that use non-aqueous as well as aqueous electrolytes have included an electrolyte separator that provides a barrier between the electrodes. The separator is typically a ceramic material that protects the lithium anode and provides a hard surface onto which lithium can be plated during recharge. However, formation of a reliable, cost effective barrier has been difficult. Thin-film barriers have been employed; however, they have been plagued by pinholes and other imperfections. Thick lithium-ion conductive ceramic plates have also been employed, particularly in lithium water cells. Having thicknesses in the range of 150 um, these plates offer excellent protective barrier properties, however, they are difficult to fabricate and are expensive. In addition, these ceramic plates add significant mass to the cell resulting in a significant reduction in specific energy storage capability relative to the otherwise high performance available using lithium-air technology.

It can be appreciated that it would be useful to have a rechargeable lithium-air battery that has an anode whose effectiveness is not significantly diminished during discharge-recharge cycling.

### SUMMARY OF THE INVENTION

The present invention provides an enhanced anode environment for lithium-oxygen batteries. The invention employs an anode environment that mitigates undesired effects of oxygen upon the anode.

In a first embodiment, a lithium anode and an air cathode are separated from one another by a lithium-ion-conductive electrolyte separator including material having low oxygen permeability.

In an aspect of the first embodiment, the lithium anode comprises substantially pure lithium metal.

In another aspect of the first embodiment, at least one of the lithium anode and the air cathode comprise binder material, lithium-ion-conductive material and electronically-conductive material.

In a further aspect of the first embodiment, the lithium anode further includes at least one lithium-affinity material. As a facet of this aspect, the lithium-affinity material includes one of silicon, aluminum and graphite.

In a yet a further aspect of the first embodiment, the electrolyte separator comprises dense material having low oxygen permeability.

In still a further aspect of the first embodiment, the electrolyte separator comprises a film layer that comprises metal oxide, is lithium-ion conductive and has low oxygen permeability.

In a second embodiment of the invention, a cell comprises lithium-affinity anode material capable of receiving and retaining lithium in a state that is not significantly adversely affected by the presence of oxygen during cell charging and recharging and an air cathode separated by a lithium-ion-conductive electrolyte separator.

In an aspect of the second embodiment, at least one of the lithium-affinity anode and the air cathode comprise binder material, lithium-ion-conductive material and electronically-conductive material. In a facet of this aspect, binder material and lithium-ion-conductive material comprise the same material.

In another aspect of the second embodiment, the lithium-affinity anode comprises at least one of silicon, aluminum and graphite.

In a further aspect of the second embodiment, the lithium-affinity anode material comprises dense material having low oxygen permeability.

In a yet a further aspect of the second embodiment, the electrolyte separator comprises dense material having low oxygen permeability.

In still a further aspect of the second embodiment, the electrolyte separator comprises a film layer that comprises metal oxide, is lithium-ion conductive and has low oxygen permeability.

### BRIEF DESCRIPTION OF THE DRAWINGS

FIG. 1 is a graph of charge-discharge cycling of a typical lithium-air (lithium-oxygen) cell exhibiting the short-comings of the prior art.

FIG. 2 is a schematic representation of a lithium-oxygen cell constructed in accordance with the teachings of the present invention.

FIG. 3 is a scanning electron microscope (SEM) image of cathode material suitable for use in the present invention.

FIG. 4 is a schematic diagram illustration of a porous, high-surface-area air cathode such as that shown in the image of FIG. 3.

FIG. 5 is a schematic illustration of an electrochemical process occurring during recharge in a lithium-oxygen cell.

FIG. 6 is a schematic illustration of anode degradation that can occur due to formation of mossy lithium formation during recharge with subsequent lithium oxide or lithium peroxide formation.

FIG. 7 is a schematic illustration of discharge-related reactions in a lithium-oxygen cell having limited oxygen diffusion into the anode, in accordance with the present invention.

FIG. 8 is a schematic illustration of components and reactions leading to in situ formation of a diffusion barrier at an anode-electrolyte interface in a lithium-oxygen cell, in accordance with the present invention.

FIG. 9 is a schematic illustration of stages in a process for constructing a lithium-oxygen cell having a lithium metal anode, in accordance with the present invention.

FIG. 10 is a schematic illustration of later stages in a process for constructing a lithium-oxygen cell having a lithium metal anode, in accordance with the present invention.

FIG. 11 is a schematic illustration of stages of a process for constructing a lithium-ion-oxygen cell having a lithium-affinity anode, in accordance with the present invention.

FIG. 12 is a schematic illustration of final stages of a process for constructing a lithium-ion-oxygen cell having a lithium-affinity anode, in accordance with the present invention.

### DETAILED DESCRIPTION

Embodiments of the present invention are described herein. The disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, at least some specific structural and functional details disclosed herein are not to be interpreted as limiting, but merely as a basis for the claims and as a representative basis for teaching one skilled in the art to variously employ the present invention.

Although the term “battery” technically may more properly define a combination of two or more cells, it has come to be used popularly to refer to a single cell. Thus the term battery by itself is sometimes for convenience of explanation used herein to refer to what is actually a single cell. The teachings herein that are applicable to a single cell are applicable equally to each cell of a battery containing multiple cells.

### Overview

As an overview, the invention teaches a lithium-oxygen battery cell in which anode reaction is enhanced by facilitating the formation of a more effective anode during charging. A more effective anode is formed by providing an anode environment that promotes the formation of lithium metal, lithium alloys or intercalated lithium anode material of a substantial quality during charging that is suitable for effective discharge reaction.

In one embodiment, a favorable anode environment is provided through employment of a lithium-ion-conductive electrolyte separator that includes material having low oxygen permeability. In a second embodiment, a favorable anode environment is provided through employment of characteristics of a lithium-ion battery. That is, the anode is formed of a material other than lithium metal, which material is of a nature that is often used in lithium-ion batteries. In particular, the invention contemplates silicon, aluminum and graphite as these materials. Materials of this nature have an ability to draw lithium ions into their structure and thereby mitigate damaging effects of degradation that may be experienced by pure lithium metal onto which lithium is plated. These materials are considered to have an affinity for lithium and, thus, are sometimes referred to herein as “lithium affinity materials” or “lithium-affinity anodes.”

The present invention employs a combination of electrode structures and electrolytes whereby different structure and different electrolyte formulation may be employed in each of the two electrodes. The formulation and structure of the cathode is selected to maximize the availability of oxygen. On the other hand, the anode is designed for minimum oxygen availability. Operation is such that an oxygen depletion region is created in the anode. Lithium deposited at the anode during recharge can react with any available oxygen. Once the oxygen in the anode is consumed, lithium deposited in the anode during recharge can be stabilized by reacting with the active material of the anode. Diffusion of additional oxygen to the anode is limited by the design of the cell.

Stable operation of the cell can be enhanced by the formation of an ion-conductive-lithium-oxide or lithium-peroxide reaction product in the form of a crust at the anode electrolyte separator interface. This crust can act as a barrier to further limit oxygen access to the anode. As lithium ions enter the electrically conductive anode from the separator, they are reduced to lithium atoms and plated at the interface. This material can subsequently react with any oxygen that is present at the anode. Since oxygen diffusion into the anode is low, the oxygen reactions occur primarily at the interface thus forming a crust that restricts oxygen access to the anode's internal regions. Lithium oxide is a high impedance lithium ion conductor; however, with a very thin crust or with the presence of at least a small amount of liquid within the crust, transfer of lithium ions back and forth between the anode and cathode during charge/discharge operation can be maintained.

Researchers J. Read of the Army Research Laboratory, Adelphi, Md. 20783-1197, United States of America, has published research studies noting that studying the cathodes of lithium air cells, has demonstrated the dependence of cathode capacity on oxygen absorption. Oxygen absorption is a function of electrolyte Bunsen coefficient (α), electrolyte conductivity (σ), and viscosity (η). The trend of decreasing cathode lithium reaction capacity with increasing viscosity and decreasing Bunsen coefficient is very apparent in Read's data. Consistent with this trend, the electrolyte used in the anode of a cell constructed in accordance with the present invention is selected for low oxygen availability. Such a cell having an oxygen-starved anode would limit lithium-oxide reaction products formed within the anode, thus allowing the deposited lithium to react with the active anode material and remain stable and available for subsequent discharge reactions. On the other hand, the electrolyte and structure of the cathode of a cell constructed in accordance with the present invention is selected for high oxygen availability.

Silicon-carbon nano-composite has been shown to cycle lithium at capacity levels in the range of 600 mAh/g (M. K. Datta and P. N. Kumta, J. Power Sources. 158 (2006) 557). These capacity levels are based on the reaction capacity of silicon-carbon with lithium in an oxygen-free environment. Crystalline silicon has also been shown to convert to amorphous LiₓSi during the first reaction with lithium. (P. Limthongkul, Y.-I. Jang, N. J. Dudney, and Y.-M. Chiang, Acta Mater, 51, 1103) (2003). M. N. Obrovac and L. J. Krause, have reported reversible cycling of crystalline silicon powder as an anode material at a capacity in the range 1000 mAh/g using sodium carboxmethyl cellulose as a binder at 8%, also in an oxygen free environment (J. Electrochem. Soc. 154, A103 (2007). Further, FMC Corporation, Lithium Division, has commercialized a Stabilized Lithium Metal Powder (SLMP™) based on lithium composites (Lectro™ Max lithium powder) for use in anodes of lithium-ion batteries. These materials react with lithium at a potential between 0 and 1 Volt relative to lithium and thereby renders the anode more stable.

### DESCRIPTION IN DETAIL

Referring now to the drawings, wherein like numerals indicate like elements throughout the several views, the drawings illustrate certain of the various aspects of exemplary embodiments.

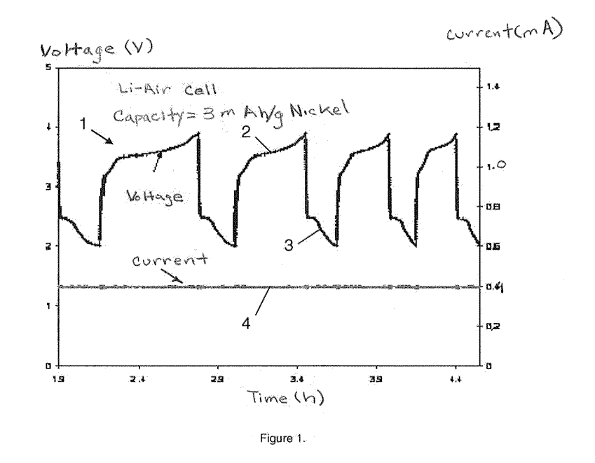

FIG. 1 shows a representative charge discharge voltage curve for a state of the art lithium air cell. Voltage curve 1 shows charge voltage 2 and discharge voltage 3. Both the charge and discharge processes occur at the same magnitude of current 4. The progressive shortening with and associated reduction in capacity with each cycle is very apparent. This high rate of capacity fade has been a long standing problem for rechargeable lithium air batteries and has represented a significant barrier to their commercialization. The formation of mossy lithium powder and dendrites at the anode-electrolyte interface during cell recharge is a significant contributor to this problem. The present invention addresses this problem.

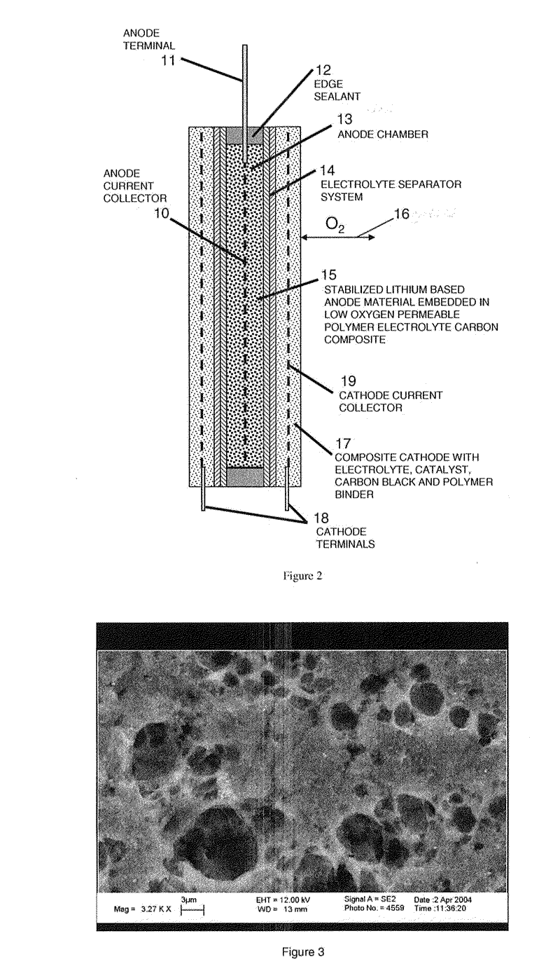

With reference to FIG. 2, there is shown an embodiment of a lithium-oxygen, or lithium-air, battery embodying the principles of the invention in a preferred form. The battery shown is configured having two cathodes 17 mounted back to back with a common anode layer 15 sandwiched in between, although other configurations are possible. To avoid degradation associated with formation of powdery lithium oxide during recharge, anode 15 includes silicon, graphite or other lithium active material as opposed to lithium metal as typically employed in lithium oxygen cells. It may also contain suitable carbon material for electronic continuity and a polymer binder. Lithium oxidation reaction sites are not desired in the anode. Carbon fibers and graphitic carbons materials have been demonstrated to provide electronic continuity but very little lithium-oxygen oxidation reaction capacity within polymer composite electrodes. As such, these types of carbons are more desirable for use in the anode for electronic continuity and the amount of carbon black employed in the anode is minimized. Both the anode and cathode may employ non-woven carbon fiber material as an electrochemically stable current collector. In addition, the presently disclosed lithium air ion battery employs a different electrolyte composition and construction for the anode than that used in the cathode. The anode material is embedded in an electrolyte such as polyethylene oxide, ionic liquid or other electrolyte, including organic solvent based chosen to have low oxygen permeability in order to minimize available oxygen. The active anode material reacts with lithium at low voltage in a reversible reaction. The open circuit voltage of the cell is the lithium reaction potential difference between lithium and the active anode material vs. lithium and oxygen in the cathode. The cells are joined together by edge sealant 12. An optimum anode is constructed as a dense structure and is bonded to the separator.

It has also been shown that the inclusion of certain electrolyte additives such as Vinylene carbonate (VC), a polymerizable analogue of ethylene carbonate (EC), prevents exfoliation of graphitic anodes (H. Ota, Y. Sakata, A. Inoue, S. Yamaguchi, J. Electrochem. Soc., 151 (10), A1659-A1669 (2004)). Triacetoxyvinylsilane (VS) is a silicon containing polymerizable additive that has been shown to reduce interfacial impedance at the lithium surface and increase cycle life in cells having lithium intercalating cathodes such as LiCoO2, LiNiO and LiMnO (Y. M. Lee, J. E. Seo, Y.-G. Lee, S. H. Lee, K. Y. Cho, J.-K. Park, Electrochem. Sol. State Lett., 10 (9), A216-A219 (2007)). These additives have been shown by the present inventor to improve the cycle stability of lithium air cells. With the use of active anode material and optionally electrolyte additives, the amount of lithium available for cycling between the anode and cathode during charge and discharge of the cell remains high. Further, by using an anode structure that limits the rate of oxygen diffusion into the anode, the amount of oxygen available for reactions with lithium in the anode is constrained. The resulting oxygen starved state of the anode allows lithium deposited there during the recharge process to react with the active anode material as opposed to being consumed in reactions with dissolved oxygen.

Although anodes constructed in accordance with the present invention are designed to minimize oxygen availability, cathodes constructed in accordance with the present invention are porous and designed to enhance oxygen transport. Similar to the anode, the bulk material of the cathode includes binder, active material, carbon and electrolyte. The active material in the cathode is oxygen that diffuses in from the cells environment. The electrolyte with in the bulk cathode material may be liquid, gelled polymer or solid. The pores in the bulk material are on the order of 1 to 20 micron in diameter and are open. They are not filled with polymer and may not be filled with electrolyte. The pores allow free passage of oxygen or air throughout the cathode's structure.

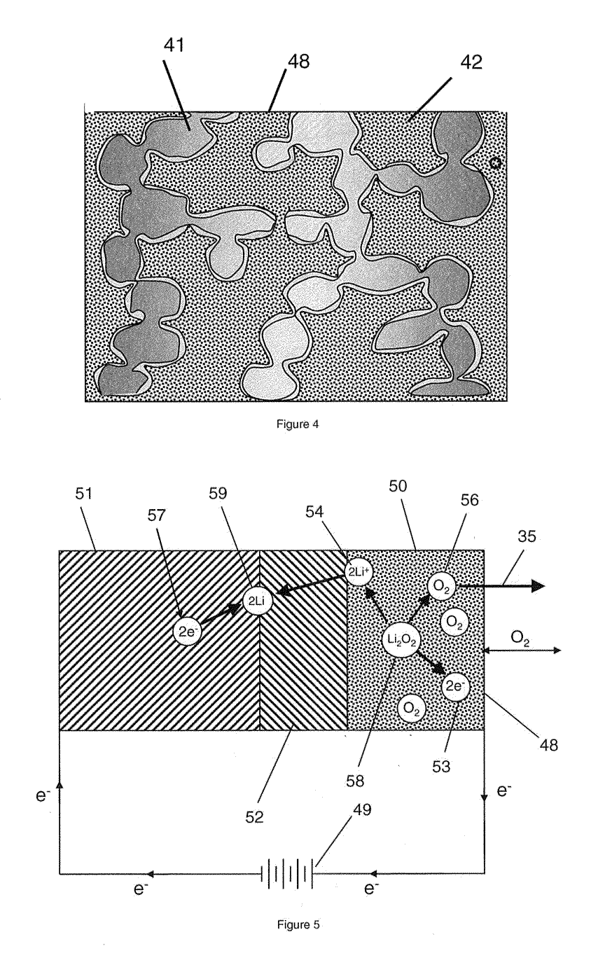

A representative cathode of the present invention is shown in FIG. 3. The cathode shown in is porous so that it allows oxygen to freely migrate beneath its surface before actually entering and diffusing through bulk material to reach reaction sites. FIG. 4, is a representative diagram of a cathode such as that in FIG. 3 showing air passages 41 extending into the structure of bulk cathode material 42 from top surface 48. These passages provide pathways for oxygen to pass into and out of the cathode. Thus, with this configuration, the actual thickness of bulk material that oxygen has to diffuse through in order to reach reaction sites is very thin which results in high cell discharge rate capability.

Suitable carbon material such as acetylene black (Alfa Aesar, Ward Hill, Ma.) or Super P (TIMCAL America Inc.; Westlake, Ohio) is employed in the cathode. The carbon material used in the cathode is selected to provide electronic continuity within the polymer binder matrix and at the same time provide an abundance of reaction sites for the formation of lithium oxide and lithium peroxide reaction product. The cathode also includes a catalyst such as electrolytic manganese dioxide (EMD) to catalyze lithium oxidation reactions as well as reduction reactions that occur during discharge charge operation of the cell.

To insure the rechargeability of a Li/O₂ battery, it is desired to preferentially form Li₂O₂ (instead of Li₂O) during the discharge process. FIGS. 5 through 8 show a schematic diagram including reactions of a cell representative of the present invention. Referring to FIG. 5, shown is a lithium air cell having Anode 51 and cathode 50 coupled to each other by electrolyte separator 52. Recharge power source 49 is electrically coupled between anode 51 and cathode 50 to supply recharge current to the cell. Cathode 50 includes air interface surface 48 which facilitates migration of oxygen into and out of the cell.

FIG. 5 illustrates the electrochemical processes ongoing in the cell during recharge. Lithium peroxide molecule 58 is electrolyzed into representative lithium ion 54 and oxygen 56 with the extraction of electron 53. Ideally, oxygen 56 is released to the oxygen source in the cells environment as illustrated by arrow 35. The recharge circuit supplies electrons 57 to the anode. Lithium ions 54 are conducted to anode 51 by the electrolyte separator 52. Lithium 59 is formed as lithium ions 54 are reduced by electrons 57 which eventually results in the formation of two lithium atoms 59 thus deposited at the anode.

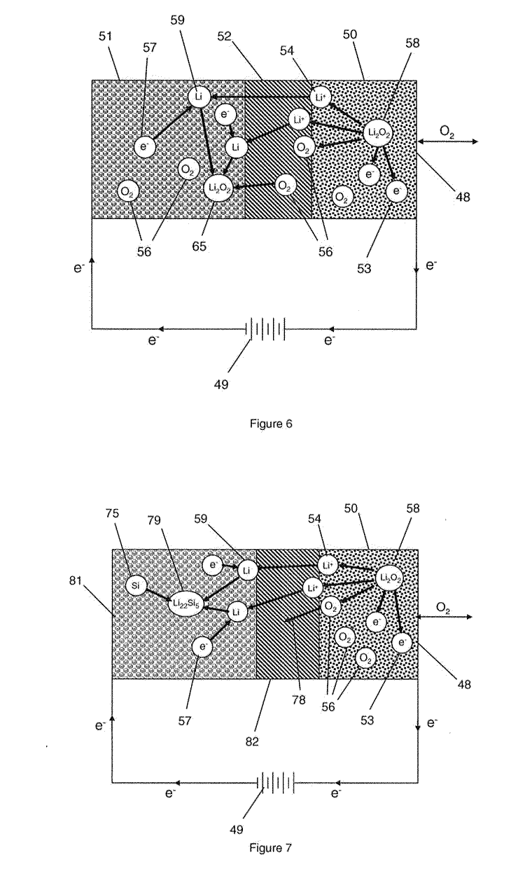

FIG. 6 shows a degradation process which can occur in lithium air cells that employ lithium metal anodes. Primarily, the degradation of concern occurs during recharge. Lithium 59 deposited at the anode during recharge can deposit as dendrites or mossy, low density material. The deposited lithium can react with oxygen 56 that may be generally present throughout the cell to form lithium oxygen reaction product such as lithium peroxide 65. In the presence of liquid electrolyte, lithium metal anodes can form a protective surface coating or passivation layer. Mossy lithium can be consumed and passivated via such reactions. In addition, lithium oxide formed on the surface of lithium in the presence of oxygen also tends to stabilize its surface. However, repeated cycling can break up such protective surfaces resulting in the formation of a mixture layer of mossy lithium, lithium-oxide and lithium-electrolyte reaction products. The presence of the mossy lithium, lithium-oxide and lithium-electrolyte reaction products at the metal anode's surface can cause the cell's impedance to increase.

FIG. 7 illustrates a cell having features that are representative of the present invention. In this case, as opposed to lithium metal, anode 81 is comprised of a composite structure of polymer binder, carbon black for electrical conductivity and silicon active anode material. The binder and electrolyte employed in the anode 81 and separator 82 are selected for low oxygen permeability and availability. In this cell, since diffusion of oxygen 56 to the anode is limited, lithium 59 is remains free to react with silicon 75 to form lithium-silicon compound 79. On occasions when an oxygen molecule manages to migrate to anode 81, lithium oxide product may be formed. However, given the limited diffusion rate, the formation of lithium oxide reaction product consumes oxygen and effectively maintains the oxygen depletion state of the anode such that the desired operational behavior of the anode is preserved.

It has been demonstrated in prior lithium oxygen cells that reaction product forms at the air interface surface of the cell's cathode when discharge rates are sufficiently high relative to the oxygen diffusion rate (J. Read; Journal of The Electrochemical Society, 149 (9) A1190-A1195 (2002). Since oxygen does not have time to reach significant depth into the cathode under this condition, a lithium oxide reaction product crust forms at the air interface surface of the cathode. Once formed, this crust on the surface of the cathode acts as a barrier to further oxygen infusion into the cell thus shutting down its power output.

As opposed to the problem as presented by Read for the cathode, the in situ crust formation phenomenon may be employed in the present invention to enhance performance. Because of low oxygen diffusion rates within the anode, a reaction product crust can form at the anode electrolyte interface in a cell constructed in accordance with the present invention. As opposed to the degradation effect observed in the past, the crust formed at the anode electrolyte interface as disclosed herein actually improves the performance. Further, cells designed in accordance with the present invention are designed for high oxygen transport rates within the cathode by using a porous structure having very high air interface area.

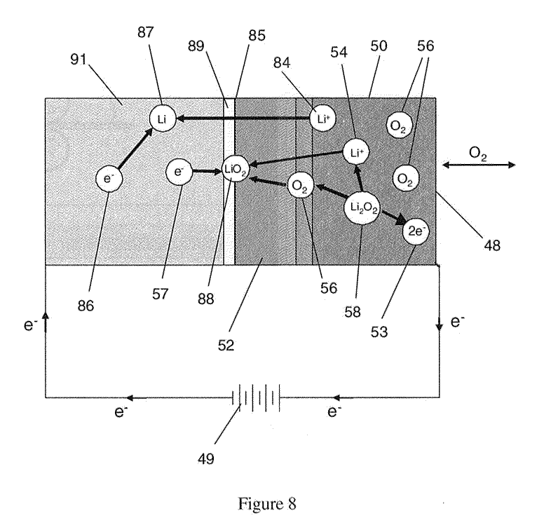

Referring to FIG. 8, lithium metal at the anode can react with oxygen 56 that may diffuse through the separator to form lithium oxide 88 or lithium peroxide. This process can result in the formation of a lithium oxide crust 89 at the anode electrolyte interface. The lithium oxide crust, being very thin and lithium ion conductive, improves reliable charge discharge operation of the cell. Once formed, crust 89 acts as a barrier to further diffusion of oxygen into the anode making it possible for lithium ions 84 to be conducted into anode 91 and exist as un-oxidized metal 87 thus available for discharge. Anode 91 may be an active anode comprised of silicon or other compound that reacts with (or has an affinity for or an affinity to react with) lithium to aid in suppression of low density metal formation.

### Example of Production of Lithium Air Cell Example (Lithium Metal Anode)

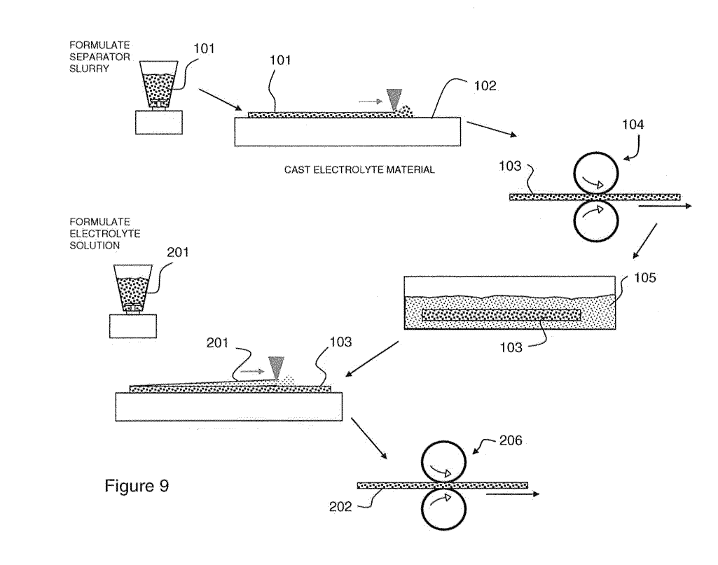

Referring to FIG. 9, first, a porous separator is formed by mixing slurry 101 comprised of PMMA micro spheres, sodium carboxmethyl cellulose and water. Fillers such ceramic powder (i.e. aluminum oxide nano-powder or fumed silica) may also be included in the slurry to improve the structural rigidity of the final film. Slurry 101 is cast onto a non stick surface 102 and allowed to dry. Resulting film 103 is next dried under vacuum at elevated temperature to remove any residual moisture. The resulting film is then calendared using hot rollers 104 at 120° C. to obtain high density and a smooth surface. The film is rinsed in acetone 105 to dissolve out the PMMA and yield a porous separator. Alternatively, commercially available porous separators such as those manufactured by Celgard Corporation may be employed.

Next electrolyte 201 solution is prepared by mixing Polyethylene Oxide (PEO) and lithium tetrafluoborate (LiCF₃SO₃) in acetonitrile solvent at elevated temperature. The electrolyte solution is cast onto the previously prepared porous separator film 103 and allowed to soak in and dry at room temperature. The resulting composite film 202 is calendared 206 using a laminator at 120° C.

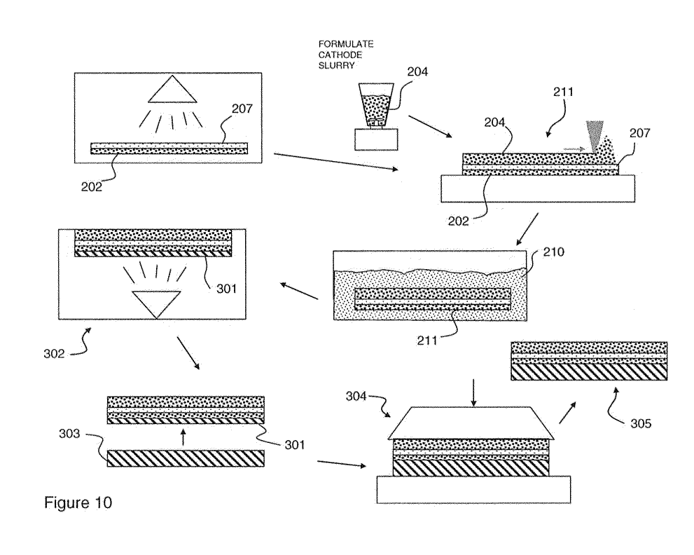

Referring to FIG. 10, at this point an optional ceramic barrier electrolyte layer 207 is applied to the thus formed separator. A film of glass electrolyte such as Lithium Phosphorous Oxy-Nitride, Lithium Niobium Oxy-Nitride or Lithium Boron Oxy-Nitride may be coated onto the separator. Physical deposition techniques such as sputtering may be employed. The barrier coating may optionally be applied to both sides of the separator. The barrier layer aids in preventing migration of liquid electrolyte and oxygen through the described polymer layer. The thus formed separator will provide a dry solid interface for the anode in order to minimize lithium dendrite plating during recharge by eliminating the availability of liquid electrolyte to the anode.

Cathode slurry 204 is formed as a mixture of Super S Carbon Black, PEO, LiTFSI salt, PMMA micro-spheres and acetonitrile solvent. The mixture may include a catalyst such as electrolytic manganese oxide. The slurry 204 is cast directly on top of the prior constructed glass electrolyte coated composite separator 202 and allowed to dry. The resulting separator/cathode composite 211 is then rinsed in acetone 210 to remove the PMMA micro-spheres from the cathode to create the desired cathode pore structure.

With completion of the cathode/separator structure 211, the lithium anode can now be bonded to the exposed surface of the separator opposite the cathode. First a seed layer 301 of 3 μm of lithium is evaporated onto the separator. The coating is applied inside a lithium evaporation chamber 302. Next, a sheet of lithium foil 303 in then applied to the surface and fused to the lithium seed layer under heat and pressure using hot press 304 to complete construction of the cell. With completion of the cell 305, small amount of liquid electrolyte is added to the cathode to enhance ionic conductivity. In the case where PEO is employed as a binder, the addition of liquid electrolyte improves the ionic conductivity within the cathode beyond that of the PEO alone. The amount of electrolyte added to the cathode is limited to an amount sufficient to fully plasticize or become gelled in the polymer bind so as to have minimal impact on the open pore structure to maintain free migration of air within the cathode.

### Example of Production of Lithium-Ion-Air Cell (Lithium-Affinity Anode)

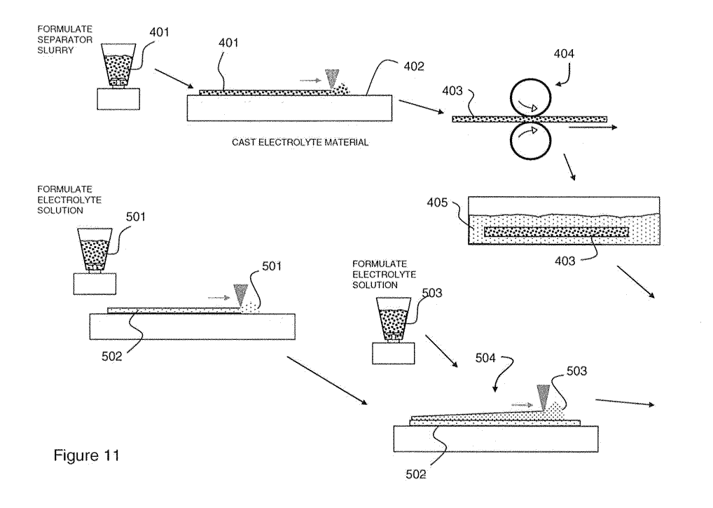

Referring to FIG. 11, a Lithium Ion Air Cell having a low oxygen permeable anode/separator structure may be formed by first constructing a porous separator. Separator 401 slurry is formed by mixing PMMA micro spheres and sodium carboxmethyl cellulose in water. Fillers such ceramic powder (i.e. aluminum oxide nano-powder or fumed silica) may also be included in the slurry to improve the structural rigidity of the final film. The slurry is cast onto a non stick surface 402 an allowed to dry. The resulting separator film 403 is next calendared using a laminator 404 at 120° C. to obtain a dense smooth film. The film is then rinsed in acetone 405 to dissolve out the PMMA and yield a porous separator. Alternatively, a commercially available porous separator such as that manufactured by Celgard corporation may be employed.

Next an anode is constructed using anode mixture 501 that includes Silicon Powder as an active anode material, sodium carboxmethyl cellulose as a binder and Super S Carbon Black for electronic continuity. The mixture is stirred and subsequently cast to form anode film 502 on a non-stick surface and allowed to dry. Next electrolyte 503 is prepared by mixing PEO and lithium tetrafluoborate (LiCF₃SO₃) in acetonitrile solvent at elevated temperature. The electrolyte solution is cast (504) over the previously prepared anode film 502 and allowed to soak in.

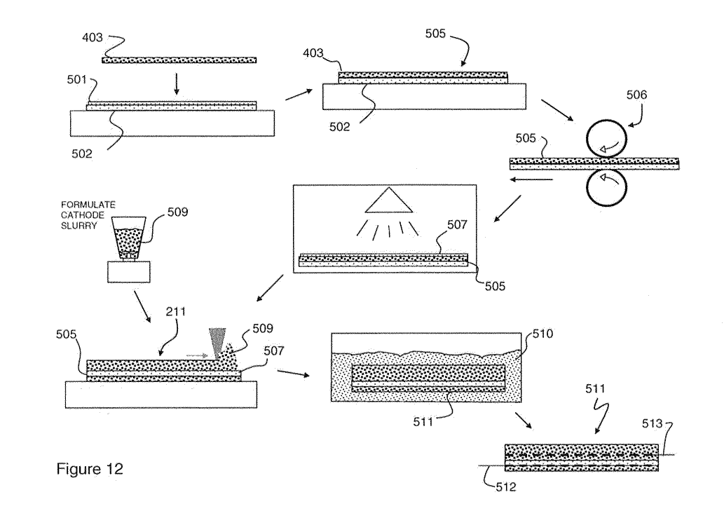

Referring to FIG. 12, while the surface of anode 502 is still wet with electrolyte solution 503, porous sheet 403 of previously formed porous separator material is laid on top such that the solvent latent electrolyte solution will soak in and distribute itself throughout the porous anode and separator. After drying, the composite film 505 is calendared into a dense composite using a hot roller 506 at 120° C.

At this point an optional ceramic barrier electrolyte layer 507 may be applied to the exposed electrolyte separator surface. A coating of Lithium Niobium Oxy-Nitride or Lithium Boron Oxy-Nitride may be sputter coated onto the separator to form such a barrier. The barrier layer will aid in preventing migration of liquid electrolyte and oxygen through the described polymer layer. The thus formed separator will provide a dry rigid interface for the anode in order to minimize lithium dendrite plating during recharge by eliminating the availability of liquid electrolyte to the anode.

Cathode slurry 509 is formed as a mixture of Super S Carbon Black, PEO, LiTFSI salt, PMMA micro-spheres and acetonitrile solvent. The mixture may include a catalyst such as electrolytic manganese oxide. The slurry 509 is cast directly on top of the prior constructed composite separator film 505 on the opposite side from the anode (on top of the glass electrolyte coating if present) and allowed to dry. The anode/separator/cathode composite 511 is then rinsed in acetone 510 to remove the PMMA micro-spheres from the cathode to create the desired cathode pore structure. Anode and cathode current collectors/terminals 512 and 513 respectively are embedded within their respective electrodes during the casting process. Putting the current collectors/terminals in place during the casting process so that they are embedded within the electrodes is a straight forward process and not explained in detail herein.

The thus formed lithium air cell 511 is next subjected to a charge cycle to electrolyze the Li2O2 in the cathode to remove it and thereby create the desired pore structure within the cathode. Simultaneously, the initial charging of the cell supplies lithium to the anode for subsequent charge discharge cycling.

### Alternate Approach for Cathode Construction

An alternate approach for constructing the cathode is to employ Polyvinylidene difluoride (PVDF) as a binder. PVDF may be plasticized by including dibutyl adipate (DBA) or other suitable plasticizer in a solvent based slurry of cathode material. The cathode slurry may also include an agent such as ammonium carbonate or lithium peroxide (preferably lithium peroxide) for producing micron scale pores in the final film. After evaporation of volatile solvent such as acetone leaving a solid cathode structure, the DBA is removed using an alcohol rinsing process prior to adding the electrolyte. The plasticizer increases the amount of liquid electrolyte that can be absorbed into the polymer. In polymer based electrode systems, the liquid electrolyte component may plasticize the polymer or it may occupy sub-micron pores within the electrode. After drying, in the case where ammonium carbonate is used, residual ammonium carbonate particles are removed by sublimation by warming the substrate to an elevated temperature. This process is disclosed in a prior patent application of the assignee of the present invention.

In the case where lithium peroxide is used, construction of the cell is completed prior to removing the lithium peroxide. After completion, the cell is subjected to a charge cycle whereby the lithium peroxide is electrolyzed away leaving pores in the cathode in place of the lithium peroxide particles.

It is now seen that use of an active anode material in combination with anode and separator electrolyte having minimal oxygen permeability and availability significantly enhances the rechargeability of lithium air cells. As in conventional lithium ion batteries, the use of active anode material also improves the safety of lithium air cells.

The separator employed by the invention may or may not include a glass or ceramic electrolyte layer to provide enhanced protection for the anode.

Many variations and modifications may be made to the above-described embodiments without departing from the scope of the claims. All such modifications, combinations, and variations are included herein by the scope of this disclosure and the following claims.

1. An electrochemical cell comprising:
a lithium anode and an air cathode separated from one another by a lithium-ion-conductive electrolyte separator including material having low oxygen permeability.

2. The electrochemical cell of claim 1, wherein the lithium anode comprises substantially pure lithium metal.

3. The electrochemical cell of claim 1, wherein at least one of the lithium anode and the air cathode comprise binder material, lithium-ion-conductive material and electronically-conductive material.

4. The electrochemical cell of claim 1, wherein the lithium anode includes at least one lithium-affinity material capable of receiving and retaining lithium in a state that is not significantly adversely affected by the presence of oxygen during cell charging and recharging.

5. The electrochemical cell of claim 1, wherein said lithium-affinity material consist of one of silicon, aluminum and graphite.

6. The electrochemical cell of claim 1, wherein said electrolyte separator comprises dense material having low oxygen permeability.

7. The electrochemical cell of claim 1, wherein said electrolyte separator comprises a film layer that comprises metal oxide, is lithium-ion conductive and has low oxygen permeability.

8. An electrochemical cell comprising:
lithium-affinity anode material capable of receiving and retaining lithium in a state that is not significantly adversely affected by the presence of oxygen during cell charging and recharging and an air cathode separated by a lithium-ion-conductive electrolyte separator.

9. The electrochemical cell of claim 8, wherein at least one of said lithium-affinity anode and said air cathode comprise binder material, lithium-ion-conductive material and electronically-conductive material.

10. The electrochemical cell of claim 9, wherein said binder material and said lithium-ion-conductive material comprise the same material.

11. The electrochemical cell of claim 8, wherein said lithium-affinity anode consists of at least one of silicon, aluminum and graphite.

12. The electrochemical cell of claim 8, wherein said lithium-affinity anode comprises dense material having low oxygen permeability.

13. The electrochemical cell of claim 8, wherein said electrolyte separator comprises dense material having low oxygen permeability.

14. The electrochemical cell of claim 8, wherein said electrolyte separator comprises a film layer that comprises metal oxide, is lithium-ion conductive and has low oxygen permeability
